(19) United States
(12) Patent Application Publication
(10) Pub. No.: US 2006/0085209 A1
(43) Pub. Date: Apr. 20, 2006

(54) Establishment of vehicle item categories

(76) Inventor: Joseph Stevens Walker III, Matthews, NC (US)

Correspondence Address: MARCIA L. DOUBET, P. O. BOX 422859, KISSIMMEE, FL, 34742, US

(21) Appl. No.: 10/968,486

(22) Filed: Oct. 19, 2004

(51) Int. Cl. G06Q 99/00

(52) U.S. Cl. 705/1

(57) ABSTRACT

At year-end, vehicles in a dealership's inventory are programmatically assigned an item category and base price for each vehicle is validated, as may be required to take advantage of favorable tax treatment. Manufacturer-provided vehicle model codes are often not consistently unique or specific enough for this purpose. Preferred embodiments compare a dealer-provided base price and vehicle descriptors (such as manufacturer, model year, and model code) for each vehicle (and, in some cases, purchase date) to a reference listing. Once a match is found, the vehicle item category is then set to a unique identifier, as determined from this comparison. The base price may be programmatically validated, in some aspects.

### BACKGROUND OF THE INVENTION

1. Field of the Invention

The present invention relates to computer software, and deals more particularly with programmatically establishing an item category for a vehicle (where this item category may be particularly useful, for example, in accounting computations).

2. Description of the Related Art

Vehicle dealerships and/or their accounting firms perform end-of-year accounting procedures that include valuation of their on-hand inventory. The Internal Revenue Service (hereinafter, “IRS”) allows dealerships special beneficial tax treatment on their inventories when certain guidelines are followed in these accounting procedures. In particular, IRS Revenue Procedure 97-36 (hereinafter, “Rev. Proc. 97-36”) states that taxpayers electing Last-In, First-Out (“LIFO”) accounting techniques must classify each vehicle in ending inventory and assign it an “item category”, and then validate the dealership's base price for the vehicle. Rev. Proc. 97-36 further states that this item category “must be determined using the entire manufacturer's base model code number that represents the most detailed description of the base vehicle's characteristics, such as model line, body style, trim level, etc.” However, some manufacturers use the same model code number to identify base vehicles with different detailed descriptions. For example, the manufacturer might assign an identical model code number to a vehicle of a particular type without regard to whether that vehicle has 2-wheel drive or 4-wheel drive. IRS audit guidelines use the term “shared-code” to describe this situation.

In current practice, due to the shared-code issue, the item category for a given vehicle is typically determined by physically reviewing the manufacturer's factory invoice and using information from the invoice to manually assign an appropriate category. In a shared-code situation, this manual categorization typically must take into consideration not only the model number code printed on the invoice, but also the descriptive statements on the vehicle's invoice, where these statements are often are needed to identify features such as body style and trim level.

As will be obvious, for a dealership having a large inventory, a huge administrative burden results when this type of manual invoice review is required. Even for dealerships with relatively small inventories, requiring manual review and input may be burdensome, tedious, and error-prone.

Another problem in prior art techniques pertains to cost figures for vehicles in inventory. Dealerships typically enter only the invoice cost into their accounting systems, so that financial computations will reflect the price actually paid by the dealership. However, most dealerships do not enter the base cost into their accounting systems, and it is the base cost information that is required for compliance with IRS Rev. Proc. 96-37.

### SUMMARY OF THE INVENTION

The present invention defines techniques that avoid the need to subjectively and manually determine a vehicle's item category from descriptive statements on the invoice, and/or to manually validate a vehicle's base cost value. Instead, in one aspect of preferred embodiments, vehicle base cost is used to index into a repository of vehicle information. Vehicle descriptor(s) (comprising information such as the vehicle's manufacturer, model number, and vehicle model year; the vehicle's vehicle identification number, or “VIN”; or descriptive information pertaining to the vehicle) may be used in addition to base cost to index into the repository of vehicle information. Indexing the repository enables assigning and/or determining a unique item category for the vehicle. These item categories may be used to meet requirements for LIFO inventory accounting computations.

In another aspect of preferred embodiments, the present invention defines techniques for programmatically validating a vehicle's base cost. When indexing the repository (whether using only a provided base cost, or base cost plus vehicle descriptor(s)), an expected base cost value is located. When this expected base cost matches the provided base cost, the provided base cost is thus validated.

In still another aspect, embodiments of the present invention may programmatically determine the vehicle item category and programmatically validate the base cost.

In these aspects, provision may be made for vehicles for which some portion of the automated processing fails to find an exact match. For example, in an embodiment that attempts to programmatically validate the base cost, provision may be made to use approximating heuristics if the provided base cost does not exactly match.

Other advantages and features of the invention will be apparent from the following description of the invention when read in conjunction with the drawings and as set forth in the claims.

The present invention will now be described with reference to the following drawings, in which like reference numbers denote the same element throughout.

### BRIEF DESCRIPTION OF THE DRAWINGS

FIG. 1 provides a flowchart illustrating a prior art approach to determining unique vehicle item categories and validating base cost values;

FIG. 2 provides a system diagram showing how an embodiment of the invention may be deployed as a Web-accessible application or service;

FIG. 3 provides a flowchart illustrating logic that may be used when implementing some embodiments of the invention;

FIGS. 4A-4C provide tables that are used when discussing how the present invention may be used in a “shared model code” situation;

FIGS. 5-16 are used to describe operation of some aspects of the present invention in example scenarios where shared codes are not present in a dealership inventory;

FIGS. 17-20 are used to describe operation of some aspects of the present invention in example scenarios where shared codes are present in a dealership inventory; and

FIGS. 21-23 provide flowcharts depicting additional or alternative logic that may be used with embodiments of the present invention.

### DESCRIPTION OF PREFERRED EMBODIMENTS

The present invention provides techniques to programmatically determine vehicle item categories and/or information for use in validating base cost values for vehicles. These item categories and base cost values are required for compliance with IRS Rev. Proc. 97-36, and may be useful in other ways as well. As noted earlier, compliance with this revenue procedure requires vehicle dealerships to identify their vehicles with unique vehicle item categories, and to provide the base cost of each vehicle, in order to realize tax savings through year-end LIFO accounting procedures. (Reference herein to providing the item categories and base cost values for use in LIFO accounting, and compliance to IRS Rev. Proc. 97-36, are by way of illustration and not of limitation.) Using preferred embodiments, information can be programmatically determined and validated that was previously determined and validated by a manual and subjective inspection of vehicle invoices.

As an example of problems in vehicle item category assignment that arise using prior art techniques, consider Ford Explorer vehicles. A 4-wheel drive Ford Explorer is different from a 2-wheel drive Ford Explorer, according to IRS definitions, and distinguishable item categories must therefore be used when reporting these vehicles for LIFO accounting purposes. Thus, if the manufacturer uses the same model code number for 2-wheel drive Ford Explorers as it uses for 4-wheel drive Ford Explorers, further work must be performed to allow the owning dealerships to identify the vehicles with unique item categories (as required by IRS Rev. Proc. 97-36). Accordingly, when using prior art techniques, descriptive comments on the vehicle invoice must typically be consulted by a human user to determine, for a particular Ford Explorer vehicle in a dealer's inventory, whether that vehicle has 2-wheel or 4-wheel drive. (It should be noted that some manufacturer-provided model code numbers are not shared, in contrast to this example scenario, as will be discussed in more detail below.)

As an example of problems in validating a vehicle's base cost using prior art techniques, consider the same Ford Explorer vehicle. A 2-wheel drive Ford Explorer may be configured with cloth seats or with leather seats, and by IRS definitions, this distinction is not considered significant to the item categorization. Vehicles can therefore share a model code number without regard to this feature. For purposes of Rev. Proc. 97-36, the base cost of a vehicle, which does not reflect added charges for optional features such as leather seats, is required, rather than the invoice cost (which does reflect those added charges). Using prior art techniques, the dealership typically enters the invoice cost into its accounting system, so that financial computations will reflect the price actually paid by the dealership; however, most dealerships do not enter the base cost into their accounting systems.

Because of these requirements and limitations, prior art processing for year-end LIFO accounting typically requires manual data entry of all pertinent information from each vehicle's invoice. Some semi-automated approaches exist. However, to the best of the present inventor's knowledge and belief, these semi-automated solutions still require manual entry of information for all vehicles, then provide a selection list from which an item category can be selected for each vehicle. For example, for a Ford Explorer, the data entry person would enter data from the invoice, including the shared model code number. To select a specific model, the system must know that multiple choices exist for a particular model code number, and a display can then be presented from which the data entry person can make a selection that will match the vehicle's invoice description. For example, a dialog window might be provided from which the data entry person must select either a “2-wheel drive” choice or a “4-wheel drive” choice corresponding to a Ford Explorer vehicle.

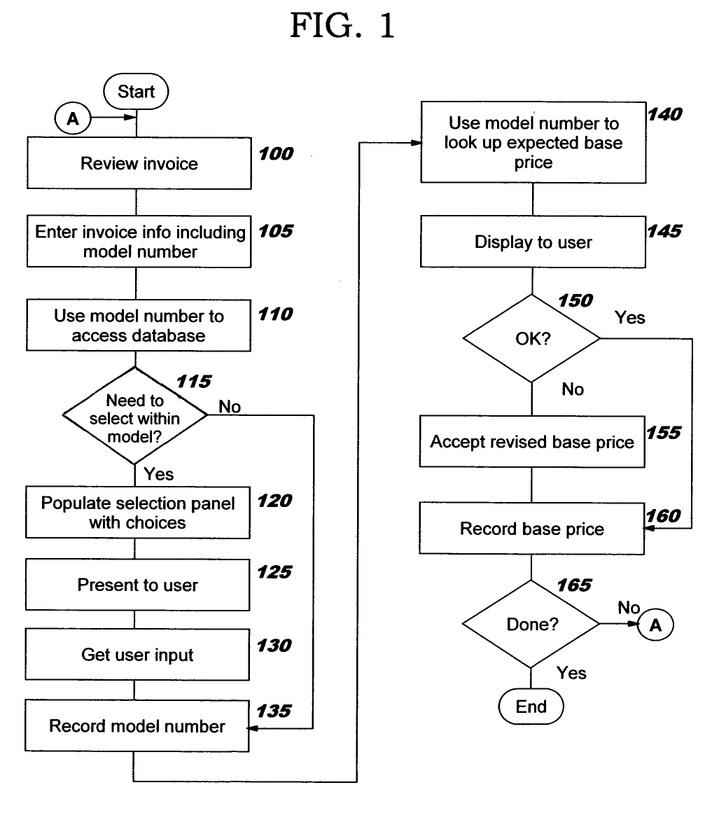

Referring now to FIG. 1, a prior art approach to determining unique vehicle item categories and validating base cost values will be described.

The invoice for a particular vehicle is reviewed (Block 100). From information recorded therein, a data entry person enters invoice information including the manufacturer-provided model code number (Block 105). This model code number may then be used (Block 110) to access a database or other repository (referred to hereinafter as a database for ease of reference).

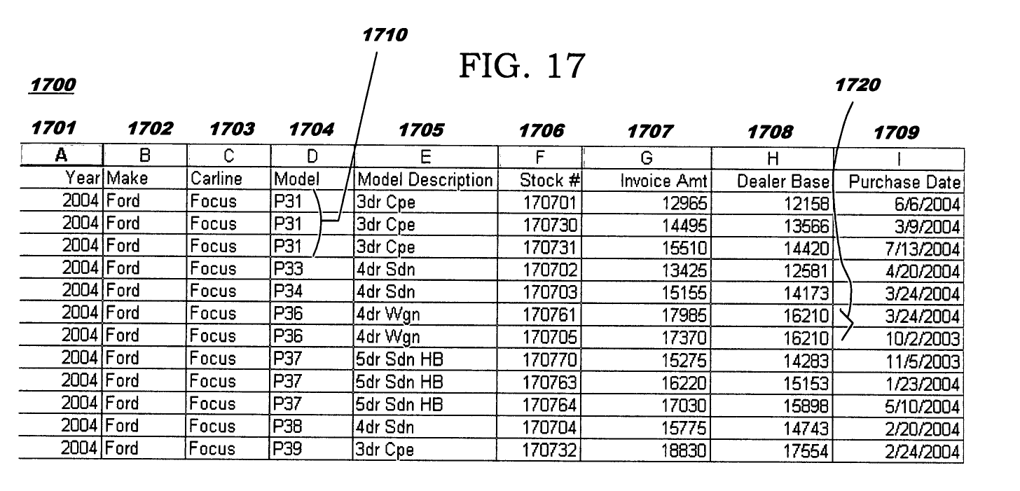

Block 115 tests to see whether the database search indicates that a selection within the model number is required. If the model number corresponds to a single choice, current applications may retrieve a vehicle description which can be presented for confirmation. In this case, the test at Block 115 has a negative result, and control transfers to Block 135. On the other hand, in a shared-code scenario, this test has a positive result. (A shared code example has been briefly discussed above when illustrating drawbacks of the prior art. The manner in which preferred embodiments address the shared code scenario is further discussed below with reference to FIGS. 17-20.)

Control reaches Block 120 when a manufacturer's model number corresponds to more than one base vehicle. A selection panel is therefore populated with choices at Block 120, where the choices to be used are determined (in a semi-automated approach) by consulting a previously-configured source such as the database used in Block 110. This populated selection panel is then presented to a human user (Block 125), and the user's selection from the provided choices is then retrieved (Block 130).

At Block 135, the model code number for the vehicle is recorded. This model code number may have been determined from the database lookup (i.e., when the test in Block 115 has a negative result), or may have been determined based on the user's selection in Block 130.

In Block 140, the model code number is then used to access a database (which may be the same database used at Block 110, or it may be a different database) in order to look up the expected base cost for this vehicle. The retrieved base cost is then displayed to the user (Block 145) for confirmation. In the prior art, the user typically confirms the base cost by manually comparing it to the vehicle's invoice. The test in Block 150 thus asks whether the user confirms the displayed base cost as being OK. If so, then control transfers to Block 160. Otherwise, processing continues at Block 155, where a revised base cost is accepted from the user. (Typically, the user will manually enter the base cost value printed on the manufacturer's factory invoice.)

Upon reaching Block 160, the base cost value is recorded. Block 165 then tests to determine whether processing for all vehicles is done. If not, control returns to Block 100 to begin processing the next vehicle. If the test in Block 165 has a positive result, on the other hand, then the processing of FIG. 1 exits.

To the best of the present inventor's knowledge and belief, no prior art approach avoids the manual selecting of the proper vehicle category in shared-code scenarios. As will be obvious, the processing of Blocks 120-130 may consume significant amounts of time for users when a large number of shared codes are present in a dealer's inventory records.

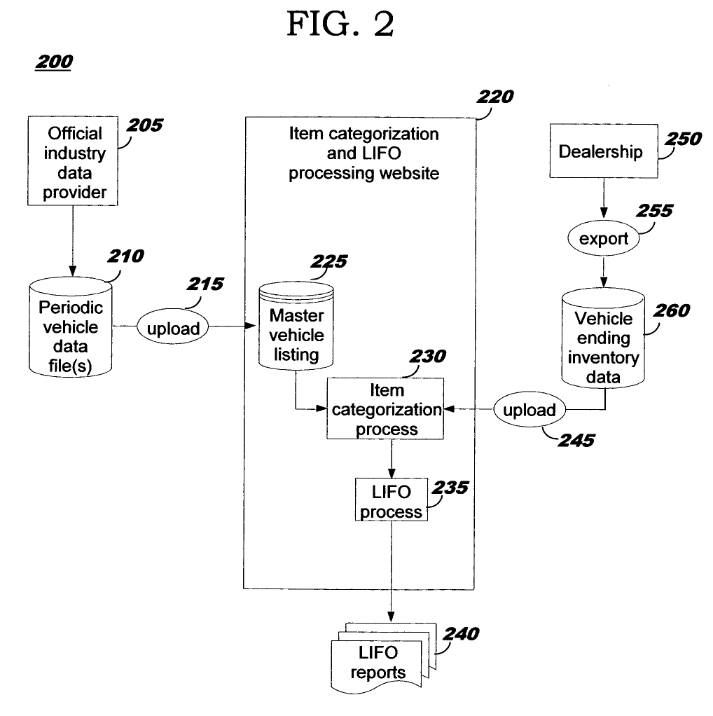

Turning now to FIG. 2, a system diagram 200 is provided showing how an embodiment of the vehicle item categorization techniques disclosed herein may be deployed as a Web-accessible application or service. Components and flows shown in FIG. 2 will now be described.

The system 200 preferably includes an application or processor (shown generally at 220) capable of implementing the item categorization techniques disclosed herein.

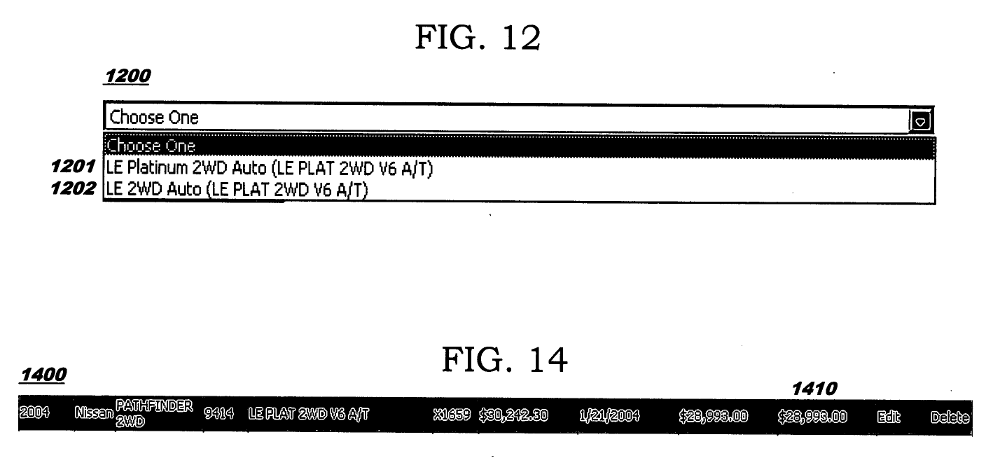

In preferred embodiments, a listing of vehicle information is provided for reference during automated comparisons. (Information from this listing may also be used by humans, as discussed below with reference to FIG. 12.) This listing is preferably embodied in computer-readable form, for example by being stored in a database or similar repository 225, and preferably comprises base vehicle descriptive data and cost information associated therewith. (The term “listing” is used herein by way of illustration and not of limitation. The stored information may be embodied in a number of ways without deviating from the scope of the present invention, such as tables in one or more relational databases, so-called “flat” or unstructured files, structured files including those represented in markup language notations, and so forth.)

Listings of the type discussed herein, comprising base vehicle descriptions and cost information, are commercially available from the various vehicle manufacturers and/or from various industry sources. In preferred embodiments, the pertinent information is obtained from an industry source 205 such as Kelley Blue Book® or Hearst Black Book®. (“Kelley Blue Book” is a registered trademark of Kelley Blue Book Company, Inc. “Black Book” is a registered trademark of Hearst Business Media Corporation.) For each base vehicle, such lists typically specify the manufacturer, the model year, the model number code, the dealer's base cost or price, and the effective date for that base cost. In addition, the listing used in preferred embodiments either contains, or enables creation of, some unique identifier for each base vehicle type. Preferably, as new vehicle models are introduced, the listing is updated to include these new models. In addition, when manufacturers change the dealer cost during the model year, the new cost and its effective date are preferably added to the listing and assigned an appropriate unique identifier for the base vehicle type.

Updates to the reference listing of vehicle information may be periodically received (see reference number 210), for example from the industry data source providing the original listing, and imported 215 into vehicle listing repository 225. Such periodic updates may include adding information pertaining to new vehicle models and/or changing cost information for existing vehicle models.

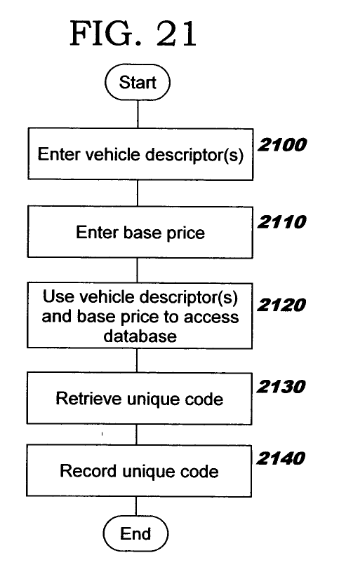

In preferred embodiments, at year-end, the dealership 250 creates 255 an electronic file 260 containing information for all vehicles currently in inventory. This file preferably contains, inter alia, the manufacturer, model year, model code number, base cost, and purchase date as entered from the manufacturer's invoice. (In some embodiments, the base cost can be subsequently entered from the invoices to augment the extracted file 260, if the base cost is not contained within the dealership's inventory system at the time of export.) The file 260 may be uploaded 245 to the web site processor 220 and processed 230 to assign the appropriate item category to each vehicle, as determined by comparing vehicle information from file 260 to the vehicle listing 225. (See also the discussion of FIGS. 21-23.) Once the item category has been assigned and the base cost has been validated, when applicable, the remaining steps in the LIFO accounting procedures 235 can be carried out in compliance with the IRS standards (where the LIFO accounting procedures themselves use techniques which do not form part of the present invention), thereby creating LIFO reports 240.

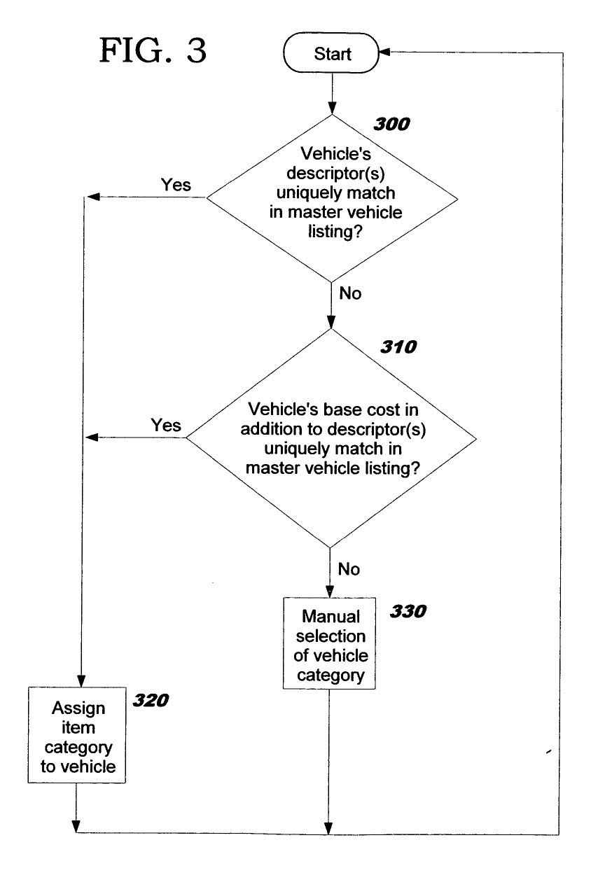

FIG. 3 provides a flowchart illustrating a high-level view of logic that may be used when implementing vehicle item categorization in aspects of the present invention. First, a vehicle's descriptors are compared (Block 300) to the reference listing of vehicles (which, as discussed above, is preferably obtained from an industry source). The descriptors may comprise a VIN; a combination of manufacturer, model year, and model code; descriptive information; etc. (Use of various types of information for descriptors is discussed in more detail below.) If this comparison at Block 300 does not yield a unique match, (indicating, typically, a vehicle with a shared model code number), then at Block 310, the vehicle's base cost is included in the comparison. If this comparison still fails to yield a match, then at Block 330, the category is preferably assigned manually. (For example, it may be necessary to manually assign item categories to those vehicles for which the inventory information contains errors, has missing information, or does not match any vehicles in the listing.) Heuristics may optionally be employed, as an alternative to manually selecting a vehicle category, as will be discussed in more detail below.

When the tests in Block 300 and Block 310 have positive results, on the other hand, this indicates that a match has been found using the reference listing. Control then reaches Block 320, where an item category is programmatically assigned to the vehicle. In one approach, the item category may be extracted from the reference listing and assigned to the vehicle. In another approach, the item category extracted from the reference listing may be concatenated to the vehicle's manufacturer-assigned model code number, and the result of this concatenation may be used as the item category assigned to the vehicle. In yet another approach, the extracted item category may be used to derive a separate unique item category (e.g., by hashing the extracted item category or using it to access a table or other lookup structure).

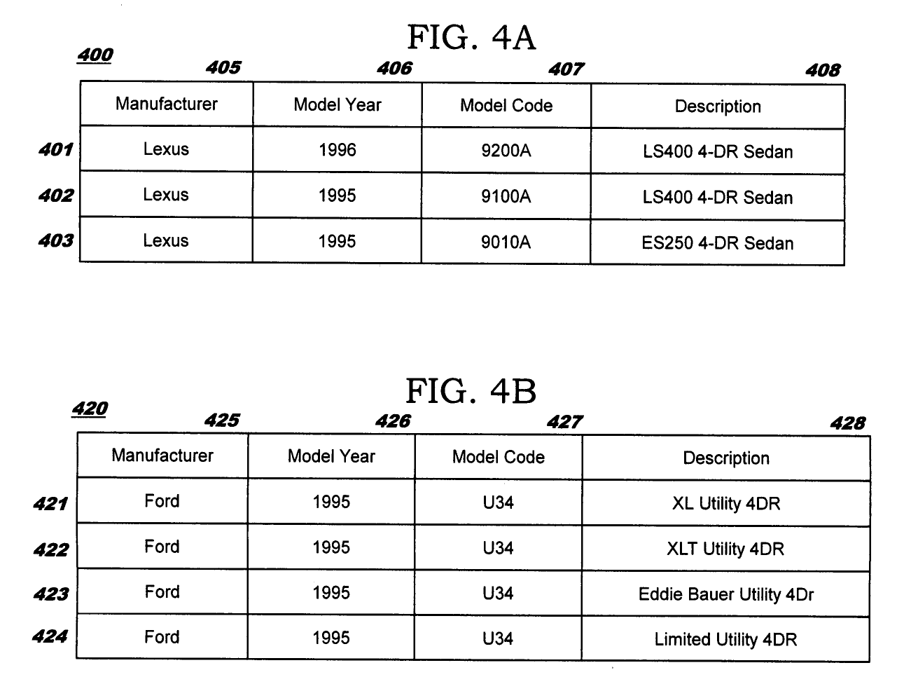

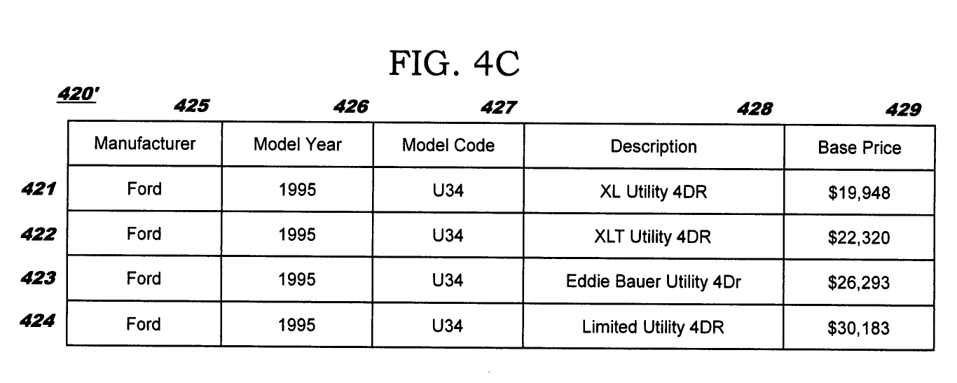

FIGS. 4A-4C provide tables that are used to illustrate how the present invention may be used in a shared model code situation, as will now be described.

Referring first to FIG. 4A, by way of contrast, a sample 400 of vehicle information is provided. As can be seen by inspection of the model code column 407, vehicles 401-403 have unique (i.e., non-shared) manufacturer-assigned model codes. Thus, for these vehicles, a combination of manufacturer 405, model year 406, and model code 407 is sufficient to yield a unique vehicle item category. (Note that in this example, the model code “9200A” for vehicle 401 is different from the model code “9100A” for vehicle 402, even though those vehicles have identical descriptions 408. This may be due to the differing model years 406, for example.)

In FIG. 4B, however, information 420 for vehicles 421-424 having shared model codes is illustrated. In this case, model code column 427 indicates the same value “U34” for each of the vehicles. However, by human inspection of the descriptions in column 428, it can be seen that the vehicles are different and therefore should be considered separately for item categorization. Therefore, a combination of manufacturer 425, model year 426, and model code 427 will not yield a unique category for these vehicles. Instead, the vehicle's description 428 must also be considered when using prior art techniques. As stated earlier, prior art techniques typically obtain this descriptive information 428 from the vehicle's invoice, using manual review of the invoices. Embodiments of the present invention avoid the requirement for a human user to inspect the vehicle's invoice for descriptive information to manually resolve shared code scenarios.

The sample data 420′ in FIG. 4C illustrates use of the base price information 429 for vehicles 421-424, according to preferred embodiments. When this information 429 is added, it can be used to differentiate the models sharing a model code number, thereby allowing the programmatic determination of a unique item category for the vehicles within this shared model code grouping. Thus, in contrast to the approach described above with reference to Blocks 120-130 of FIG. 1, it is no longer necessary to manually consult the invoice for each vehicle and review its descriptive information to determine which vehicle category should be used for vehicles having shared codes. Once the reference listing has been consulted as disclosed herein, unique item categories may be programmatically assigned to each of vehicles 421-424. A vehicle item category of “U34-1” might be assigned to vehicle 421, for example, while a category of “U34-2” might be assigned to vehicle 422 and so forth.

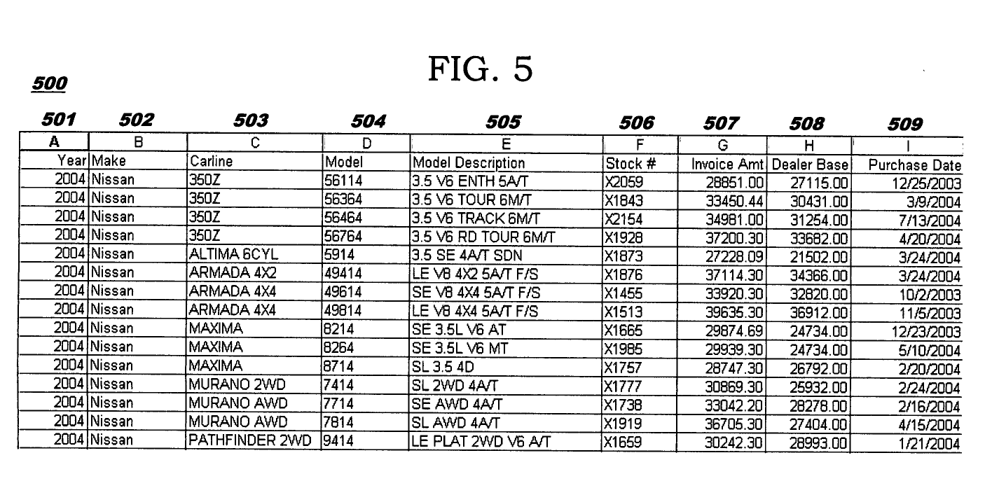

Referring now to FIGS. 5-20, operation of preferred embodiments will now be described in more detail with reference to several vehicle data samples. FIGS. 5-16 illustrate operation in a sample non-shared code scenario, according to preferred embodiments, while FIGS. 17-20 illustrate operation in a sample shared-code scenario.

In FIG. 5, sample data 500 representing a dealership's inventory information for a number of Nissan vehicles is presented. This sample data comprises the model year 501, make (i.e., manufacturer) 502, “carline” 503, manufacturer-assigned model code 504, model description information 505, stock number 506, invoice amount 507, dealer's base cost 508, and purchase date 509. (The term “carline” is used herein to refer to a vehicle brand or similar high-level descriptive information.)

Stock number 506 represents, in this sample data 500, the dealership's tracking number for each vehicle. A vehicle identification number (“VIN”) may be used alternatively for this purpose. Invoice amount 507 represents the amount paid by the dealership for each vehicle. As stated earlier, this amount represents the vehicle's base price plus any separately-priced optional features. However, IRS Rev. Proc. 97-36 requires the dealership to use the vehicle's base price in LIFO accounting procedures. This dealer base price is shown at 508. It may be necessary to use the vehicle purchase date 509 when programmatically determining a vehicle's unique item category using its base price (for example, if the price has changed within the model year).

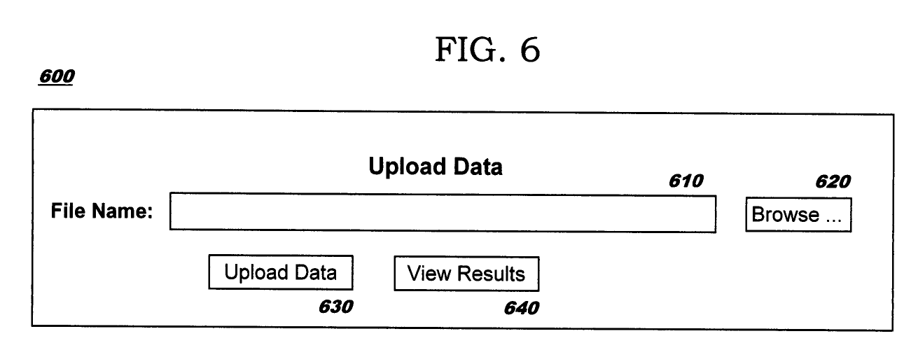

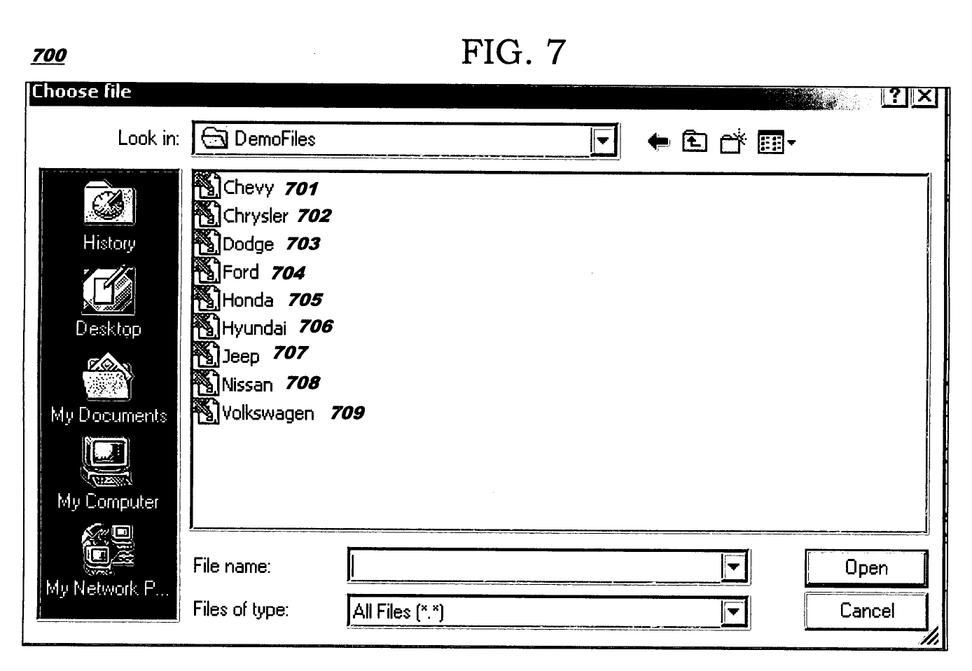

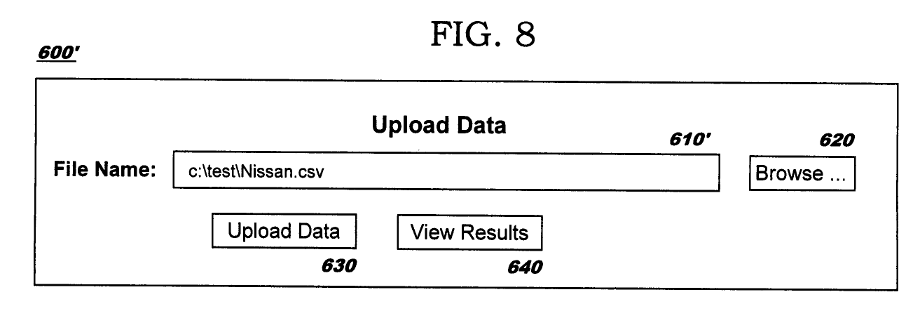

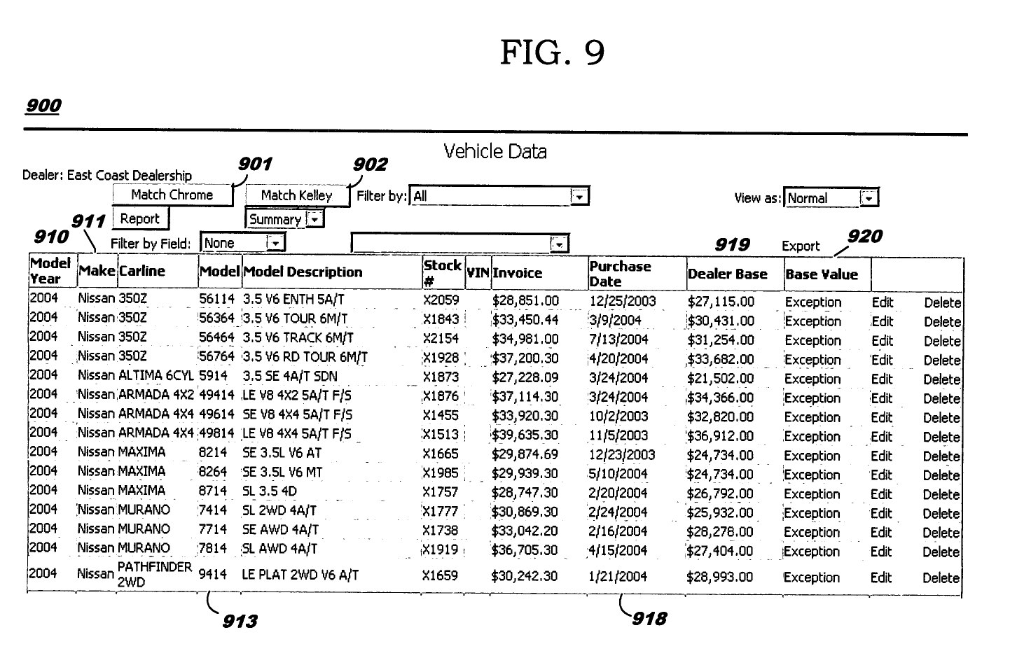

FIG. 6 provides a sample dialog box 600 illustrating how a user may be prompted to identify a source location 610 for uploading 630 a dealership's end-of-year inventory, thereby providing information of the type illustrated in FIG. 5 for item categorization processing. (This upload operation corresponds generally to reference number 245 in FIG. 2.) In FIG. 7, a sample window 700 is illustrated, showing choices that might be presented in response to the user pressing the graphical “Browse” button 620 in dialog box 600. The user may then select one of the files represented by icons 701-709, for example by double-clicking a pointing device that is positioned over the icon or its associated text. The sample dialog box 600′ in FIG. 8 indicates that, in this example, the user has selected 610′ the file named “Nissan” and having file type “csv”. (In this example, it is presumed that the file name selected at 610′ contains the data shown in table 500 of FIG. 5.) Responsive to selecting the “upload data” button 630 in dialog box 600′, the selected file is imported. A “View Results” button 640 allows the user to view results of the vehicle information processing, in this example. (Alternatively, the results may be processed and displayed responsive to selecting the “upload data” button.) A display such as that shown in FIG. 9 may be provided for showing the results, as will now be described.

In sample display 900 of FIG. 9, a “base value” column 920 has been programmatically appended to the imported data from the dealership's sample data 500. In preferred embodiments, this column initially has no amounts. Instead, a text message such as “Exception” is preferably shown for each row, and is intended to indicate that processing of this row is not yet complete. Preferably, the values for this column are programmatically determined by consulting a reference listing of vehicle information. Graphical buttons 901, 902 indicate that (in this example) two alternative reference listings are available. Upon the user activating one of these graphical buttons, in one aspect, preferred embodiments match the model year 910, make 911, and model code number 913 values to the selected reference listing. (As noted earlier, it may be necessary in some situations to include the purchase date 918 in these comparisons.)

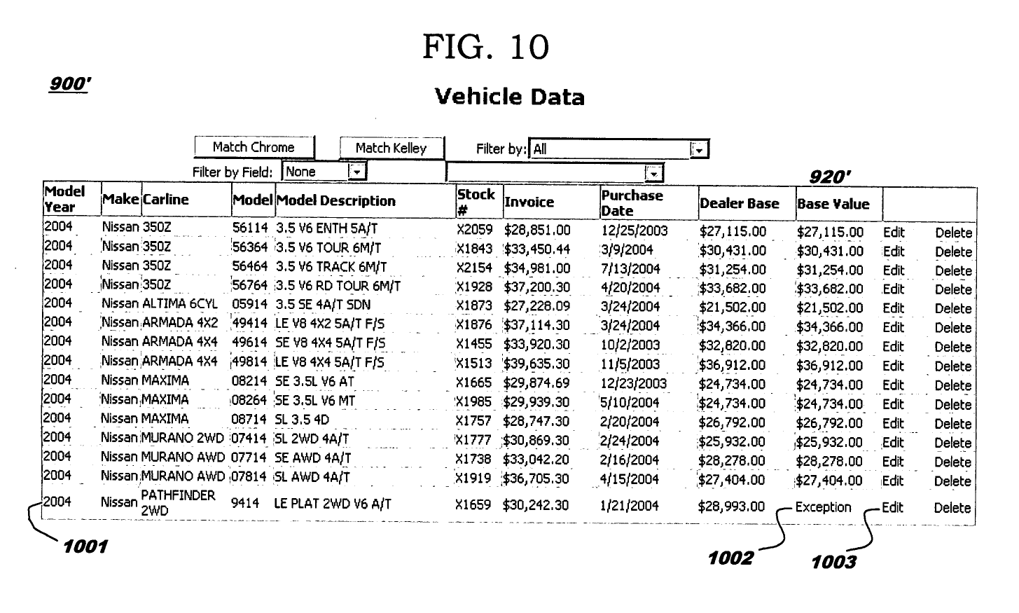

If a unique match is found when comparing a particular row from the imported vehicle data to the selected reference listing, the corresponding expected base value (i.e., expected base cost) is retrieved and is used to populate the base value column 920. An example is shown in FIG. 10. As shown therein, the base value column 920′ has entries for all but one row, indicating that the match ratio for the sample data was very high. Preferably, the user then resolves only those exception cases where the programmatic retrieval of the base cost value failed. This is in contrast to prior art techniques, where the user performs a manual validation for each vehicle by visually comparing the vehicle's expected base cost to the paper invoice. In the sample display 900′ in FIG. 10, the exception case is the row where the “Exception” label continues to be shown. See reference number 1002 in row 1001. Alternative techniques for flagging the exceptions may be used alternatively.

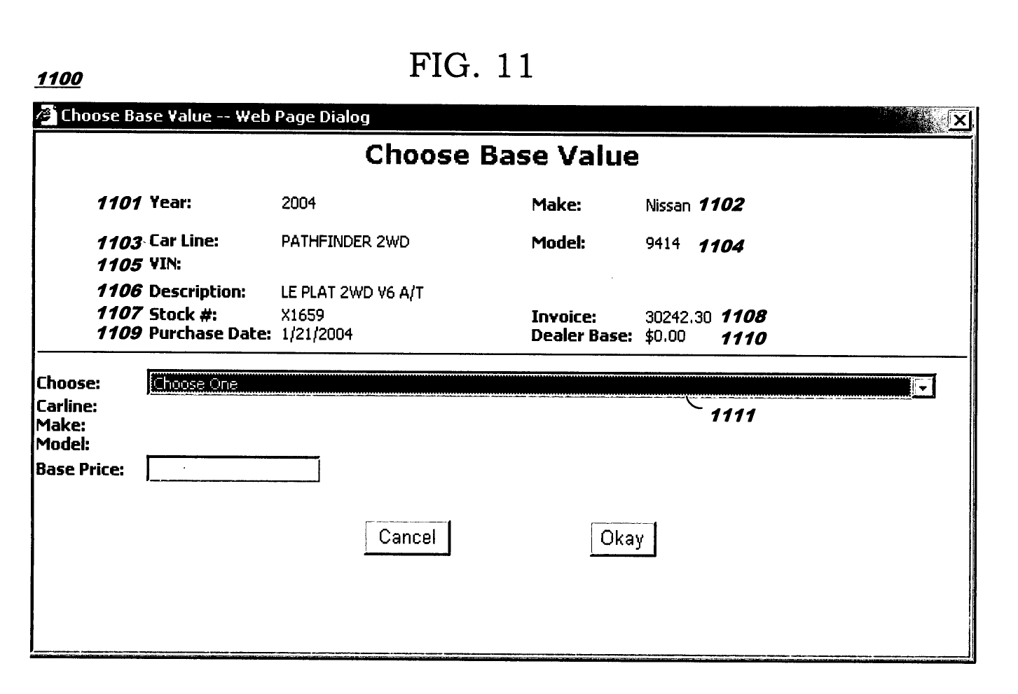

FIGS. 11-14 illustrate one approach to resolving the exception case exemplified by the row 1001 of FIG. 10 for which a base cost value was not programmatically retrieved. Preferably, the user clicks on (or otherwise activates) the “Edit” label for a particular vehicle's row of display 900′, such as the “Edit” label at reference number 1003 of FIG. 10. A data entry form of the type shown at 1100 in FIG. 11 may then be displayed. The sample data depicted in FIG. 11 corresponds to the exception case in row 1001 from FIG. 10. As can be seen by inspection, the model year 1101, make 1102, carline 1103, model 1104, model description 1106, stock number 1107, invoice amount 1108, and purchase date 1109 values from row 1001 have been used to populate data entry form 1100. (In this example, the dealer base cost has not been transferred to 1110 of form 1100, since that value has not been verified. Alternatively, the value in column 919 of FIG. 9 may be used at 1110.) By consulting stored information (preferably, in the reference listing selected by the user at 901 or 902 in FIG. 9), preferred embodiments programmatically extract descriptive information for the nearest matching vehicles and use this extracted information to populate a pull-down list 1111. See, for example, a sample pull-down list 1200 in FIG. 12, which presents two potential matches 1201, 1202 for the exception case depicted in FIG. 11.

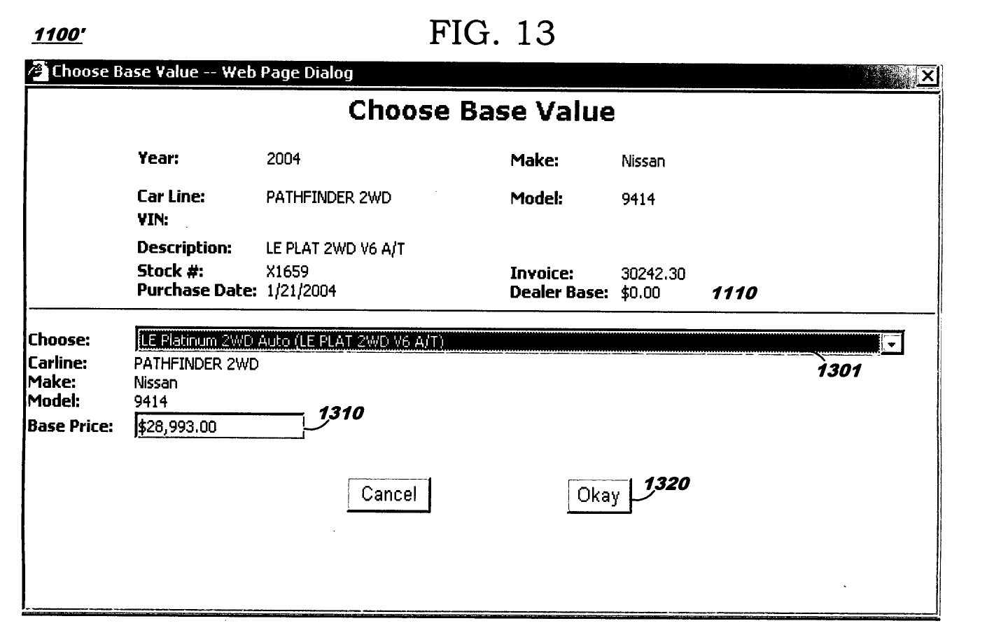

Assuming the user selects choice 1201 in FIG. 12, the data entry form is preferably revised to include that information along with a programmatically-retrieved base price value corresponding to that selection. See reference numbers 1301 and 1310 in the data entry form 1100′ of FIG. 13, for example. Optionally, when the dealer base price is shown at 1110, the user may then visually compare the programmatically-retrieved base price value 1310 to the dealer's base price value 1110 for this vehicle. (Or, the price may be compared to the paper invoice.) If the base price value is acceptable, the user preferably activates the “Okay” button 1320. FIG. 14 shows data that may then be displayed, according to this example, as a replacement for the vehicle information in row 1001 of FIG. 10 (i.e., the base price of $28,993.00, shown at 1410 of FIG. 14, replaces the “Exception” label shown in the base value column 920′ for row 1001 of FIG. 10, thereby indicating that this exception case has been resolved).

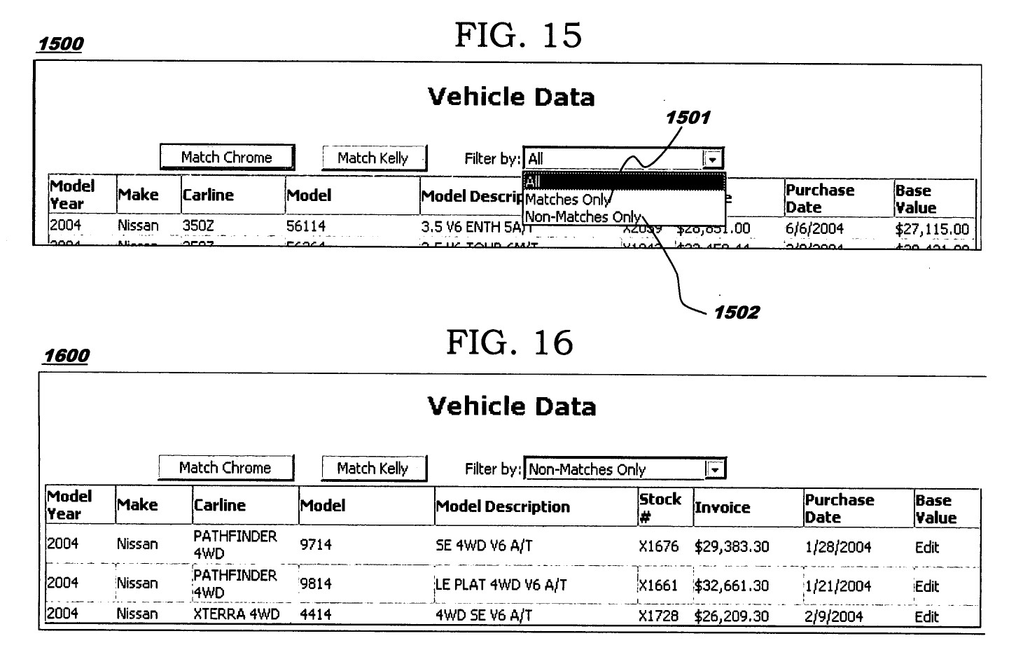

FIGS. 15-16 show an optional enhancement of preferred embodiments, whereby the results of matching imported data (such as sample data 500 in FIG. 5) against a reference listing can be programmatically filtered to display only those vehicles for which a base cost value has been retrieved (i.e., the “matches only” choice at 1501) or to show only the vehicles for which the base cost has not been retrieved (i.e., the “non-matches only” choice at 1502). Continuing with the example of FIGS. 10 and 13, suppose that 3 additional exception cases remain in sample data 900′. Thus, responsive to the user selecting the “Non-Matches Only” selection 1502, an exception case display 1600 is preferably provided to the user, as illustrated in FIG. 16. This approach of filtering may improve the user's ability to process the exception cases.

Embodiments of the present invention may be adapted for enabling the user to manually enter an appropriate value for base price (for example, by typing a value directly into the base value column in place of the “Exception” label, or by typing into dialog box 1310 of FIG. 13). Optionally, a mechanism may be provided for recording an indication that a particular base value has been manually entered (including, but not limited to, providing a flag of some type and/or a “notes” field where the user might enter comments such as “base price manually entered by employee #358”).

Turning now to FIGS. 17-20, operation of some aspects of the present invention in scenarios where shared codes are present in a dealership inventory will now be described.

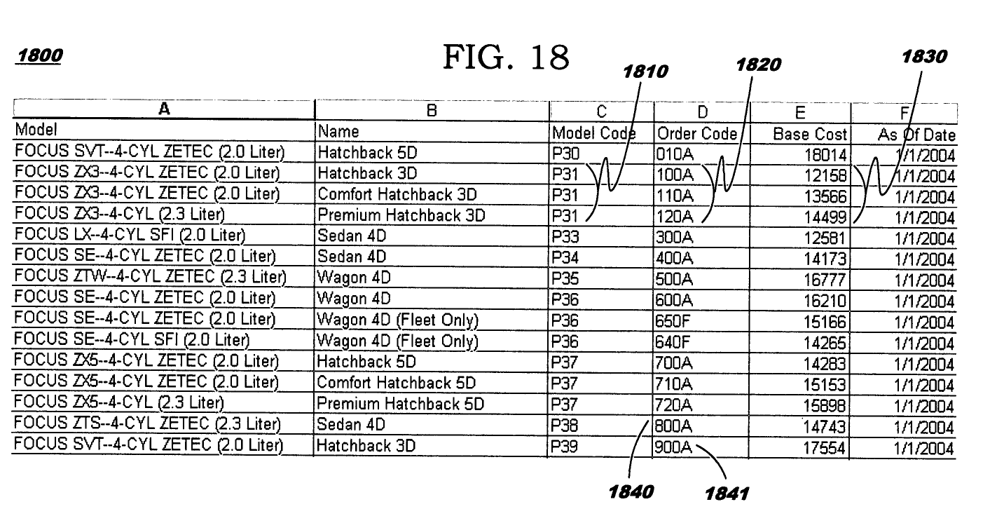

In FIG. 17, sample data 1700 represents a dealership's inventory information for a number of Ford vehicles. This sample data might be imported or uploaded (see reference number 245 of FIG. 2) responsive to the user selecting icon 704 of FIG. 7, for example. As with sample data 500 of FIG. 5, the sample data 1700 comprises the model year 1701, make (i.e., manufacturer) 1702, carline 1703, manufacturer-assigned model code 1704, model description information 1705, stock number 1706, invoice amount 1707, dealer base cost 1708, and purchase date 1709 for each vehicle in the dealership's inventory. Several of the vehicles represented in sample data 1700 use shared codes. For example, the manufacturer-assigned model code “P31” is shared by multiple 3-door Ford Focus coupes, as shown by reference number 1710. FIG. 18 depicts a partial reference listing 1800 that may be used to uniquely categorize these and other shared-code vehicles of FIG. 17, using techniques disclosed herein. See, for example, reference numbers 1810-1830, showing that the reference listing includes unique codes 1820 associated with each of three different base price values 1830 for vehicles using the shared model code “P31” 1810.

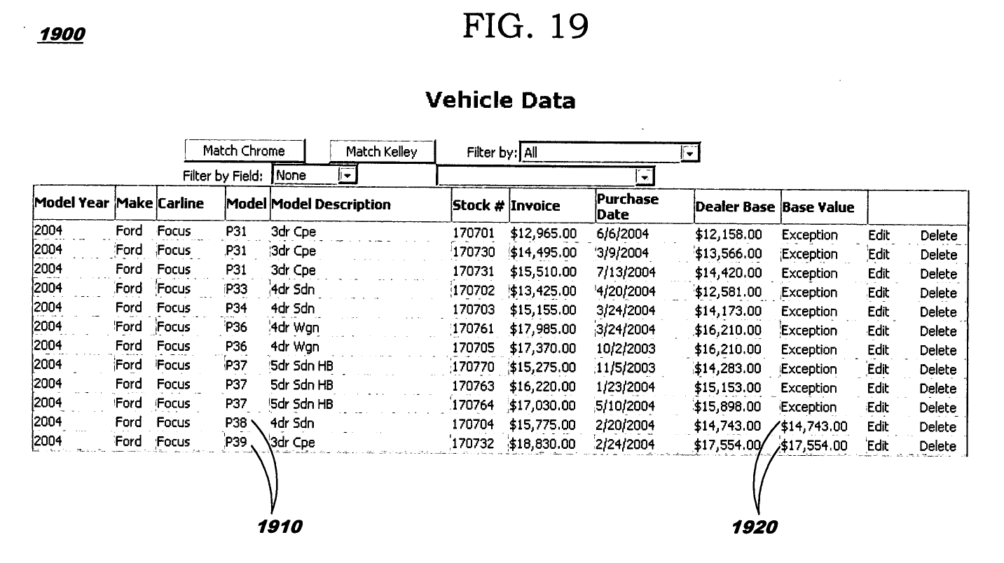

For vehicles in the sample data 1700 that do not use shared codes, a match may be made by comparing the vehicle's descriptor(s) directly to the reference listing data. This was discussed previously with reference to Block 300 of FIG. 3. A result of this matching is shown at 1900 in FIG. 19, where only the vehicles having manufacturer-assigned model codes “P38” and “P39” (see reference number 1910) have programmatically-retrieved base values (see reference number 1920) at this point. Note that, in this example, code values “800A” and “900A”, which are associated with model codes “P38” and “P39” in the reference listing 1800 (as shown at reference numbers 1840, 1841), may be concatenated to, or used in place of, the imported model codes as the vehicle's unique item category, although this is by way of illustration and not of limitation.

For those vehicles that do use shared codes, preferred embodiments use zero or more vehicle descriptors plus the vehicle's base cost, and compare this information to the reference listing data. (The manner in which the vehicle descriptors may be created is discussed in more detail below.) According to preferred embodiments, the dealership preferably enters the base cost information (in addition to the invoice price) from the vehicle's invoice directly into their automated inventory or accounting system (e.g., as an additional value entered when the invoice for a newly-arrived vehicle is entered into the dealership's system, or as a supplemental value entered at year-end for those vehicles remaining in inventory). Presumably, the base cost values are provided before the data is exported from the dealership's system, and before the data is imported for use with an embodiment of the present invention. (Alternatively, provision may be made for augmenting the exported information with base cost values, as was noted earlier.) This approach is believed to require very little additional data entry time beyond what is required for entry of the already-provided invoice data values (such as model year, stock number, and so forth). In preferred embodiments, this dealer base cost information is then used, along with the vehicle's descriptor(s), as an index into the reference listing data. (This corresponds generally to Block 310 of FIG. 3.)

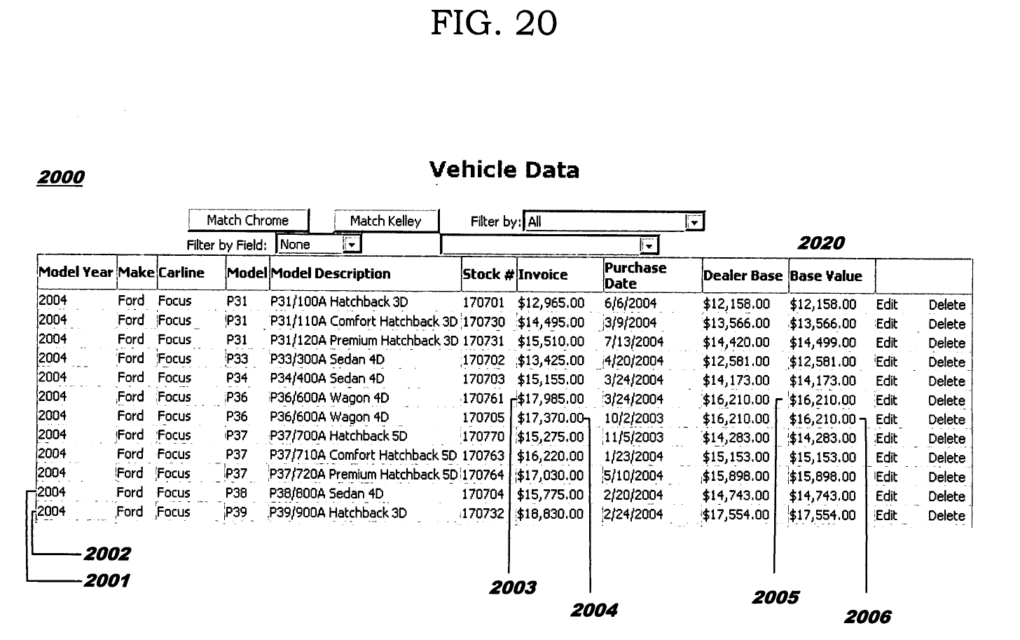

Recall that the matching logic depicted in FIG. 3 first attempted to match using vehicle descriptors such as model year, manufacturer, and model code, and if this failed to yield a unique match, another comparison was performed after including the base cost. The result data 1900 in FIG. 19 corresponds, in this example, to the first matching operation (as discussed with reference to Block 300 of FIG. 3), where expected base values are programmatically retrieved for only two of the vehicles (see reference number 1920), whereas result data 2000 of FIG. 20 illustrates how the matching is improved when dealer base cost values are also available for use in the comparison (as discussed with reference to the second matching operation, shown at Block 310 of FIG. 3). By comparison, it can be seen that FIG. 20 contains no “Exception” labels in the “base value” column 2020.

As an alternative to the 2-step matching process depicted in FIG. 3 and illustrated with results in FIGS. 19 and 20, embodiments of the present invention may use the dealer base price initially, thereby implementing a 1-step matching process. In this case, the results shown in FIG. 20 represent output of the 1-step match for the sample data 1700.

Referring to the sample base cost values in rows 2001, 2002 of FIG. 20, it can be seen that the same expected base value ($16,210.00, in this example) applies to each vehicle. Thus, according to the processing of Blocks 310 and 320 of FIG. 3, and as has been discussed herein, the same vehicle item category is appropriate for both of these vehicles, even though they presumably have different options and therefore have different invoice amounts 2003, 2004.

As demonstrated by this example, use of vehicle item categorization as disclosed herein may also provide advantages that are not limited to LIFO accounting for IRS compliance. Dealerships may find this type of vehicle categorization, which allows vehicles with identical model code numbers and base prices to be grouped together into a single item category even though the vehicles are not identically configured, useful for other processing such as sales analysis and various types of statistical processing.

The descriptors used to access the reference listing (either in combination with base price in a 1-step match, or separately and then in combination with base price in a 2-step match) may be formed in several different ways without deviating from the scope of the present invention. In one approach, a dealer-provided VIN may be used as the descriptor. In another approach, a manufacturer-assigned model code, if unique, may be used as the descriptor. In yet another approach, a combination of manufacturer, make, and model code may be used as the descriptor. (Note that a VIN may be decoded to provide, in some cases, the vehicle's manufacturer, model year, and model code or descriptive information. Publicly-available data or commercially-available software or services may be used to perform this decoding.) It should also be noted that the descriptor may be omitted, thereby relying solely on the dealer-provided base cost as an index, if base cost values are unique among vehicles.

Using vehicle descriptors when accessing the reference listing enables narrowing the range of values against which the base cost is indexed to find a unique match. More than one type of descriptor may be used. For example, if a vehicle's model number is unavailable or inaccurate, then the vehicle's general descriptive information may be used instead, while still enabling embodiments of the present invention to converge upon a match. Or, the vehicle's VIN may be used to derive a model number or description. (It should be noted that when using a larger number of vehicle descriptors, increased confidence may be attributed to the results of the matching.)

As an example of using a vehicle's description, suppose a particular vehicle is described as “Explorer”. By cross-referencing industry-provided data, such as the reference listing, it may be determined that model codes U72, U73, U74, U75, and U77 are used with vehicles having this description. Embodiments of the present invention may use a range of model codes, as in this example, along with the particular vehicle's dealer-provided base cost, to select a likely entry from the reference listing. If the vehicle description is “Explorer XLT”, on the other hand, then cross-referencing the industry-provided data may indicate that only the model code U73 is used with this description. In this case, the model code U73 can be used (in addition to, or instead of, the “Explorer XL1” description) when accessing the reference listing.

A vehicle's purchase date may be used when searching the reference listing. For example, if multiple entries exist in the reference listing for a particular descriptor and base cost combination, the effective date for the prices from those entries is preferably compared to a dealer-provided purchase date to determine which entry is applicable. Use of purchase date may also reduce search time. For example, if the reference listing contains entries for each vehicle in each month or each quarter (indicating, for example, price revisions that have occurred), the purchase date can be used to directly access an appropriate one of the entries. By contrast, if a purchase date is not provided, preferred embodiments preferably search all cost values within the vehicle's model year. When a match includes purchase date (as well as base cost and other vehicle descriptors), confidence is increased in the accuracy of the matching operation.

In some embodiments, the dealer-provided base cost is not required to exactly match the base cost from the reference listing. Instead, a heuristic approach may be used, whereby a programmatic “best guess” approximation is made as to the most likely entry for a match. Thus, embodiments may converge upon a match even though there may be, for example, data entry errors in the dealer-provided base cost information. Suppose, for example, a dealer-provided cost is $12,175 and the reference listing includes entries that match on manufacturer, model year, and shared model code, but that the base cost for these entries is $12,158, $13,566, and $15,044. Embodiments of the present invention may thus deduce that the entry with $12,158 as its base cost is preferred as a result of the match. If, however, the dealer-provided base cost is $12,800 (which is approximately midway between two of the three entries), then this may be treated as an exception case that requires human user input for resolution. When matches are resolved programmatically using approximations of this type, visual indicators may be used in the displayed results to flag values for which non-exact matching has been used.

Similarly, a range of reasonably-close purchase dates may be used when matching, in cases where an exact match on purchase date fails. It may happen, for example, that a data entry person enters a vehicle's date of receipt, rather than the vehicle's purchase date. Thus, allowing flexibility in the date match allows convergence upon a match in the presence of data entry errors. Preferably, date extensions of this type are limited to extension within a particular model year.

For very large dealerships, the programmatic matching techniques disclosed herein may reduce hours of data entry time to minutes, even though the dealership's files may contain entries for hundreds of vehicles. And, this result may be achieved for many dealerships with little to no change to current data entry processing. As has been shown, base cost values can be used (along with zero or more other existing descriptors) to programmatically determine a unique item category for the vehicle. And, even dealerships with large numbers of shared-code vehicles can easily leverage embodiments of the present invention to determine unique vehicle item categories after making relatively minor changes to their new-vehicle data entry processing (by contemporaneously entering a new vehicle's base price value) or by subsequently augmenting stored vehicle data to include dealer base cost.

In one aspect, a web-based service is deployed to provide vehicle item categorization using disclosed techniques. (Refer to the discussion of FIG. 2, where components of a sample service were described.) In this aspect, prior art authentication and access control techniques are preferably used to ensure that only authorized users are given access to a secure web site. For those users passing these checks, the site preferably enables them to upload vehicle inventory data files and match the vehicles against data provided from an industry standard source to determine the vehicles' categorization and/or to validate their base cost values, as has been described.

FIGS. 21-23 provide flowcharts depicting additional or alternative logic that may be used with embodiments of the present invention.

FIG. 21 provides a flowchart illustrating, at a high level, processing that may be undertaken by a dealership as it receives new vehicles. Upon processing the paperwork for a new vehicle, vehicle descriptors such as the manufacturer, model year, manufacturer-assigned model code number, and date of purchase are entered (Block 2100) into the computing system. Or, as stated above, embodiments of the present invention may use a VIN or descriptive information. The vehicle's base price is also entered (Block 2110), as discussed herein for use with some embodiments of the present invention. In one approach, the vehicle descriptor(s) and base price are used at the time of data entry to access a database or other repository in which a reference listing is available (Block 2120). For example, the web-accessible service may be invoked for each vehicle. When a match is found, a unique value specified in the reference listing is retrieved (Block 2130). This unique value is recorded as the vehicle item category (Block 2140) for use, inter alia, in LIFO accounting procedures. This approach is similar to that described above, but performs the vehicle item categorization processing at an earlier time and for individual vehicles.

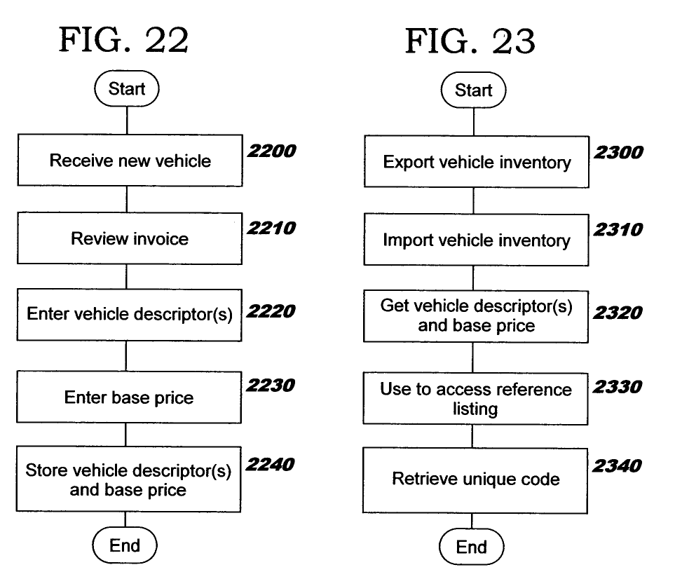

FIG. 22 provides a flowchart with an alternative approach to processing data by a dealership as it receives new vehicles. Processing for a new vehicle begins (Block 2200) when the vehicle is received. The vehicle's invoice is reviewed (Block 2210), and the vehicle descriptor(s) (Block 2220) and base price (Block 2230) determined therefrom are entered. The vehicle descriptor(s) and base price are stored (Block 2240) in the inventory system, and can be used subsequently (for example, at year end) to determine vehicle item categorization and pricing information to be used in LIFO accounting procedures. Turning then to FIG. 23, when time arrives for carrying out these LIFO accounting procedures, information pertaining to the dealership's year-end inventory is exported (Block 2300) from the inventory system and imported (if required; Block 2310) such that it is available to a system providing an implementation of techniques disclosed herein. From this imported data, the vehicle descriptor(s) and base price are obtained (Block 2320) and used to access a reference listing (Block 2330). A unique item categorization code for the vehicle can thus be determined (Block 2340).

As has been demonstrated, embodiments of the present invention establish a vehicle's item category without the need for a manual review of descriptive statements on an invoice. The use of the vehicle's base cost, along with the vehicle descriptor(s), when compared to an established or reference listing of vehicles and costs, will provide a high probability of achieving a unique category assignment. It should be noted that while operation of preferred embodiments has been described herein using particular brands of automobiles as examples, this is by way of illustration only. Techniques disclosed herein are not limited to these particular brands.

Embodiments of the present invention may be provided as computer-readable program code. For example, computer-readable program code may be used to store the vehicle listing and/or to use this listing to perform the matching operations.

Embodiments of the present invention may include automatic collection of basic vehicle data directly from a dealer's computerized inventory (e.g., via a file export operation), and subsequent import into the automated vehicle item categorization system. Exporting and importing data from existing inventory information eliminates a need to manually enter vehicle information (such as make, model, year, stock number, etc.) for the sole purpose of performing LIFO accounting computations.

As will be appreciated by one of skill in the art, embodiments of the present invention may be provided as (for example) methods, systems, and/or computer program products. The present invention may take the form of a computer program product which is embodied on one or more computer-usable storage media (including, but not limited to, disk storage, CD-ROM, optical storage, and so forth) having computer-usable program code embodied therein.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

What is claimed is:

1. A method of programmatically establishing a vehicle item category, comprising steps of:
accessing a vehicle reference repository using, as an index, a base cost associated with a particular vehicle; and
assigning, to the particular vehicle, a vehicle item category that uniquely categorizes the particular vehicle, based on results of the accessing step.

2. The method according to claim 1, wherein one or more vehicle descriptors associated with the particular vehicle are used, in addition to the base cost, as the index.

3. The method according to claim 2, wherein one of the vehicle descriptors comprises a description associated with the particular vehicle.

4. The method according to claim 2, wherein one of the vehicle descriptors comprises a manufacturer, model year, and model code associated with the particular vehicle.

5. The method according to claim 2, wherein one of the vehicle descriptors comprises a model code associated with the particular vehicle.

6. The method according to claim 2, wherein one of the vehicle descriptors comprises a vehicle identification number associated with the particular vehicle.

7. The method according to claim 2, wherein a purchase date associated with the particular vehicle is used, in addition to the base cost, as the index.

8. The method according to claim 1, wherein the accessing step further comprises the step of using, as the results of the accessing step, an entry from the vehicle reference repository where the base cost associated with the particular vehicle matches an expected base cost in the entry.

9. The method according to claim 8, wherein the vehicle item category is specified in the entry.

10. The method according to claim 8, wherein information used to create the vehicle item category is specified in the entry.

11. The method according to claim 1, wherein the accessing step further comprises the step of matching the base cost associated with the particular vehicle to an expected base cost specified in entries of the vehicle reference repository.

12. The method according to claim 1, wherein the accessing step further comprises the step of matching the base cost associated with the particular vehicle, and a purchase date associated with the base cost, to an expected base cost, as of an effective date, specified in entries of the vehicle reference repository.

13. The method according to claim 1, further comprising the steps of:
initially accessing the vehicle reference repository using one or more vehicle descriptors associated with the particular vehicle; and
accessing the vehicle reference repository using the base cost only if the initially accessing step fails to locate a unique matching entry in the vehicle reference repository.

14. A method of assigning vehicle categories to vehicles, comprising steps of:
accessing, for each of a plurality of vehicles, a vehicle reference repository using, as an index, a base cost associated with each of the vehicles; and
assigning, to each of the vehicles, a vehicle category that uniquely categorizes the vehicle, using information located by the accessing step.

15. The method according to claim 14, further comprising the steps of:
initially accessing the vehicle reference repository using one or more vehicle descriptors associated with each of the vehicles; and
accessing the vehicle reference repository using the base cost only if the initially accessing step fails to locate a unique matching entry in the vehicle reference repository

16. A system for programmatically establishing a vehicle category, comprising:
an accessor that accesses a vehicle reference repository using, as an index, a base cost associated with a particular vehicle and zero or more vehicle descriptors associated with the particular vehicle; and
an assigner that assigns, to the particular vehicle, a vehicle item category that uniquely categorizes the particular vehicle, using information located by the accessor.

17. The system according to claim 16, further comprising:
an initial accessor that initially accesses the vehicle reference repository using one or more vehicle descriptors associated with the particular vehicle; and
wherein the accessor accesses the vehicle reference repository using the base cost only if the initial accessor fails to locate a unique matching entry in the vehicle reference repository.

18. A computer program product for programmatically establishing a vehicle category, the computer program product is embodied on one or more computer-readable media and comprising computer-readable instructions for:
accessing a vehicle reference repository using, as an index, a base cost associated with a particular vehicle and zero or more vehicle descriptors associated with the particular vehicle; and
assigning, to the particular vehicle, a vehicle item category that uniquely categorizes the particular vehicle, using information located by the computer-readable instructions for accessing.

19. The computer program product according to claim 18, further comprising computer-readable instructions for:
initially accessing the vehicle reference repository using one or more vehicle descriptors associated with the particular vehicle; and
accessing the vehicle reference repository using the base cost only if the computer-readable instructions for initially accessing fails to locate a unique matching entry in the vehicle reference repository.
